(19) United States
(12) Patent Application Publication
(10) Pub. No.: US 2010/0327141 A1
(43) Pub. Date: Dec. 30, 2010

(54) DUAL-PURPOSE RECEIVING STRUCTURE SELECTIVELY APPLIED TO DESK SURFACE OR WALL SURFACE

(75) Inventor: TZU-CHIN CHIU, TAIEPI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: CAIMON ENTERPRISE CO., LTD., CHANGHUA COUNTY (TW)

(21) Appl. No.: 12/823,379

(22) Filed: Jun. 25, 2010

(30) Foreign Application Priority Data
Jun. 26, 2009 (TW) 98211618

(51) Int. Cl. F16M 13/00; F16M 13/02; A47G 29/00

(52) U.S. Cl. 248/558

(57) ABSTRACT

A dual-purpose receiving structure selectively applied to desk surface or wall surface includes a receiving unit, a retaining unit and a pin unit. The receiving unit has a receiving body and an open receiving space formed in the receiving body. The retaining unit has a retaining element disposed on the receiving body. The pin unit has a pin element. A first end of the pin element is positioned on the receiving body or embedded into the receiving body, and a second end of the pin element is a pin portion selectively positioned by the retaining element. Hence, the instant disclosure is selectively applied to the wall surface or the desk surface according to different requirements. In addition, the design of receiving one side of the pin unit in the retaining unit prevents user from being injured by the pin portion, thereby the safety of using instant disclosure is increased.

### BACKGROUND OF THE INVENTION

1. Field of the Invention

The instant disclosure relates to a dual-purpose receiving structure, and more particularly, to a dual-purpose receiving structure selectively applied to desk surface or wall surface.

2. Description of Related Art

Referring to FIG. 1, the prior art provides a wall hanging structure, including a wall hanging body 1, a hanger 2 extending forwards from a front side of the wall hanging body 1, and a pin element 3 disposed on a back side of the wall hanging body 1. When user wants to use the wall hanging structure, the pin element 3 needs to be inserted into a wall W for positioning the position of the wall hanging body 1, and then the user can hang article on the hanger 2.

However, the wall hanging structure has the following defects:

1. The wall hanging structure can only be applied to the wall W, thereby the application field of the wall hanging structure is limited.

2. When the pin element 3 of the wall hanging structure has not been inserted into the wall W yet, the user would be injured by an end pin of the pin element 3 easily. Hence, how to safely store the wall hanging structure is a real torment to the user.

### SUMMARY OF THE INVENTION

One particular aspect of the instant disclosure is to provide a dual-purpose receiving structure selectively applied to desk surface or wall surface. The instant disclosure not only is selectively applied to the wall surface or the desk surface according to different requirements, but also can prevent user from being injured by pin portions, thereby the safety of using instant disclosure is increased.

In order to achieve the above-mentioned aspects, the instant disclosure provides a dual-purpose receiving structure selectively applied to desk surface or wall surface, including: a receiving unit, a retaining unit and a pin unit. The receiving unit has a receiving body and at least one open receiving space formed in the receiving body. The retaining unit has at least one retaining element disposed on the receiving body. The pin unit has at least one pin element. A first end of the at least one pin element is positioned on the receiving body or embedded into the receiving body, and a second end of the at least one pin element is a pin portion selectively positioned by the at least one retaining element.

In order to achieve the above-mentioned aspects, the instant disclosure provides a dual-purpose receiving structure selectively applied to desk surface or wall surface, including: a receiving unit, a plurality of retaining units and a plurality of pin units. The receiving unit has a receiving body and at least one open receiving space formed in the receiving body. Each retaining unit has at least one retaining element disposed on the receiving body. Each pin unit has at least one pin element. A first end of each pin element is positioned on the receiving body or embedded into the receiving body, and a second end of each pin element is a pin portion selectively positioned by each retaining element.

Therefore, when the dual-purpose receiving structure uses the pin unit to insert into a wall, the instant disclosure can be applied to a wall surface. When one side of the pin unit is received in the retaining unit, the instant disclosure can be applied to a desk surface. Hence, the dual-purpose receiving structure of the instant disclosure can be selectively applied to the wall surface or the desk surface according to different requirements. In addition, the design of receiving one side of the pin unit in the retaining unit can prevent the user from being injured by the pin portion of the pin unit, thereby the safety of using instant disclosure is increased.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1 is a lateral, cross-sectional, schematic view of the wall hanging structure of the prior art;

FIG. 2A is one perspective, schematic view of the dual-purpose receiving structure according to the first embodiment of the instant disclosure (before receiving the pin unit);

FIG. 2B is another perspective, schematic view of the dual-purpose receiving structure according to the first embodiment of the instant disclosure (after receiving the pin unit);

FIG. 2C is a front, schematic view of the dual-purpose receiving structure according to the first embodiment of the instant disclosure (after receiving the pin unit);

FIG. 2D is a lateral, cross-sectional, schematic view of the dual-purpose receiving structure applied to a wall surface according to the first embodiment of the instant disclosure;

FIG. 2E is a lateral, cross-sectional, schematic view of the dual-purpose receiving structure applied to a desk surface according to the first embodiment of the instant disclosure;

FIG. 3 is a front, schematic view of the dual-purpose receiving structure according to the second embodiment of the instant disclosure (after receiving the pin unit);

FIG. 4 is a front, schematic view of the dual-purpose receiving structure according to the third embodiment of the instant disclosure (after receiving the pin unit);

FIG. 5 is a front, schematic view of the dual-purpose receiving structure according to the fourth embodiment of the instant disclosure (after receiving the pin unit);

FIG. 6A is one perspective, schematic view of the dual-purpose receiving structure according to the fifth embodiment of the instant disclosure (before receiving the pin unit);

FIG. 6B is another perspective, schematic view of the dual-purpose receiving structure according to the fifth embodiment of the instant disclosure (before receiving the pin unit);

FIG. 7A is one perspective, schematic view of the dual-purpose receiving structure according to the sixth embodiment of the instant disclosure (before receiving the pin unit);

FIG. 7B is another perspective, schematic view of the dual-purpose receiving structure according to the sixth embodiment of the instant disclosure (before receiving the pin unit); and

FIG. 8 is a perspective, schematic view of the dual-purpose receiving structure according to the seventh embodiment of the instant disclosure (before receiving the pin unit).

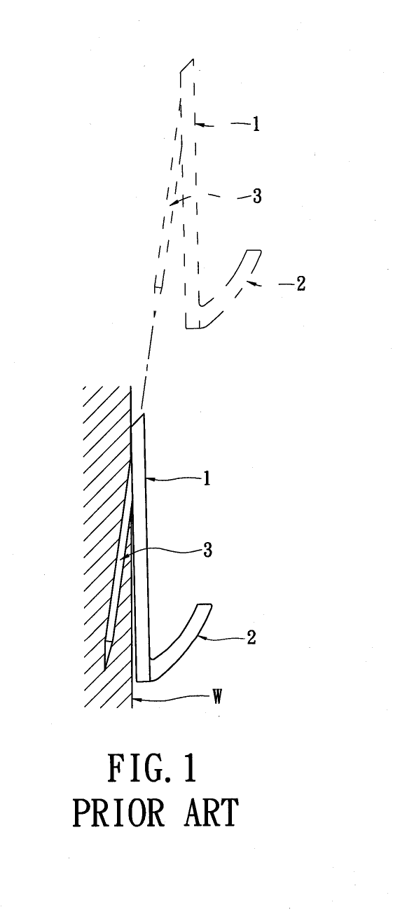

### DETAILED DESCRIPTION OF THE PREFERRED EMBODIMENTS

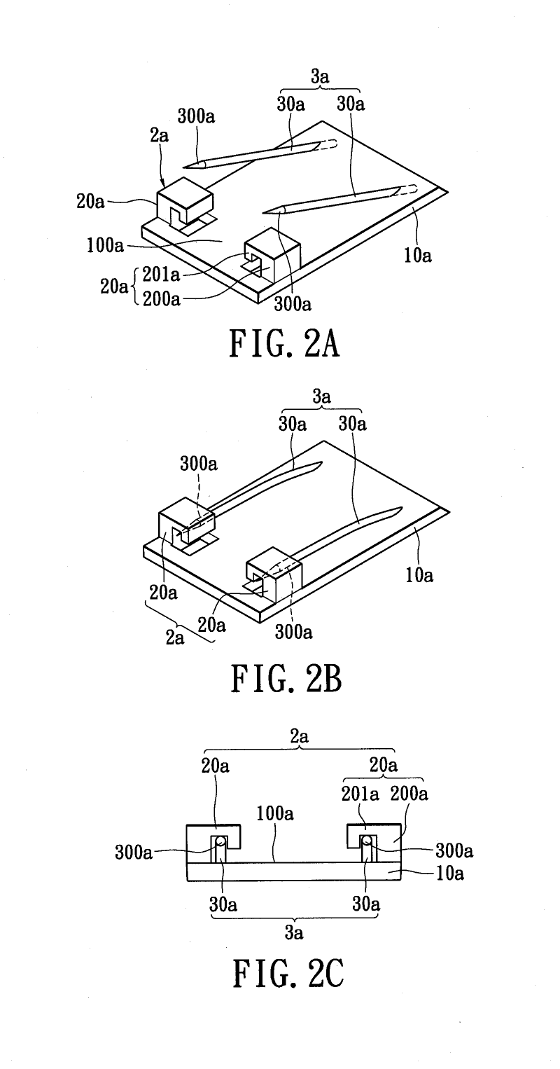

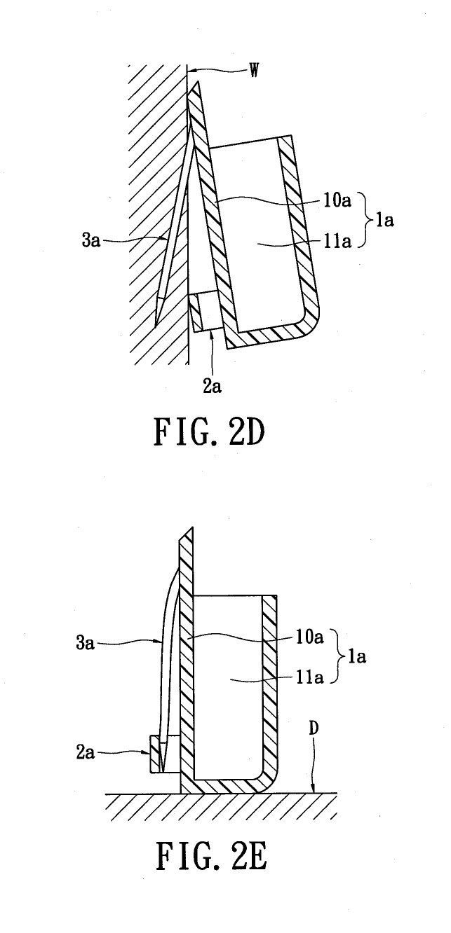

Referring to FIGS. 2A to 2E, the first embodiment of the instant disclosure provides a dual-purpose receiving structure selectively applied to desk surface or wall surface, including a receiving unit 1a, a retaining unit 2a and a pin unit 3a.

Moreover, the receiving unit 1a has a receiving body 10a and at least one open receiving space 11a formed in the receiving body 10a (as shown in FIG. 2D). One part of the receiving body 10a is omitted in FIGS. 2A to 2C, and the at least one open receiving space may be formed on a front side of the receiving body 10a.

In addition, the retaining unit 2a has at least one retaining element 20a disposed on the receiving body 10a. The first embodiment discloses two retaining elements 20a. Of course, the instant disclosure may use more than two retaining elements 20a according to different requirements. The two retaining elements 20a may be integrally disposed on a back side of the receiving body 10a. Each retaining element 20a has an extending portion 200a extended from a datum plane 100a of the back side of the receiving body 10a and a retaining portion 201a extended inwards from the extending portion 200a.

Besides, the pin unit 3a may be made of elastic material such as metal or plastic etc, and the pin unit 3a has at least one pin element 30a. The first embodiment discloses two pin elements 30a separated from each other or integrally formed with each other. Of course, the instant disclosure may use more than two retaining elements 20a according to different requirements. In addition, a first end of each pin element 30a is embedded into the receiving body 10, and a second end of each pin element 30a is a pin portion 300a selectively positioned by each retaining element 20a. Therefore, each pin portion 300a may be positioned by each retaining portion 201a as shown in FIGS. 2A and 2B.

In other words, one end of each pin unit 30a is embedded into the back side of the receiving body 10a, thereby each pin unit 30a has a predetermined elasticity. Hence, another end of each pin unit 30a is selectively suspended (as shown in FIG. 2A) or is pressed and retained in the each retaining element 20a (as shown in FIGS. 2B and 2C).

Furthermore, when the dual-purpose receiving structure uses the pin unit 3a to insert into a wall, the instant disclosure can be applied to a wall surface W (as shown in FIG. 2D). When one side of the pin unit 3a is received in the retaining unit 2a, the instant disclosure can be applied to a desk surface D (as shown in FIG. 2E). Hence, the dual-purpose receiving structure of the instant disclosure can be selectively applied to the wall surface W or the desk surface D according to different requirements. In addition, the design of receiving one side of the pin unit 3a in the retaining unit 2a can prevent the user from being injured by the pin portion 300a of the pin unit 3a, thereby the safety of using instant disclosure is increased.

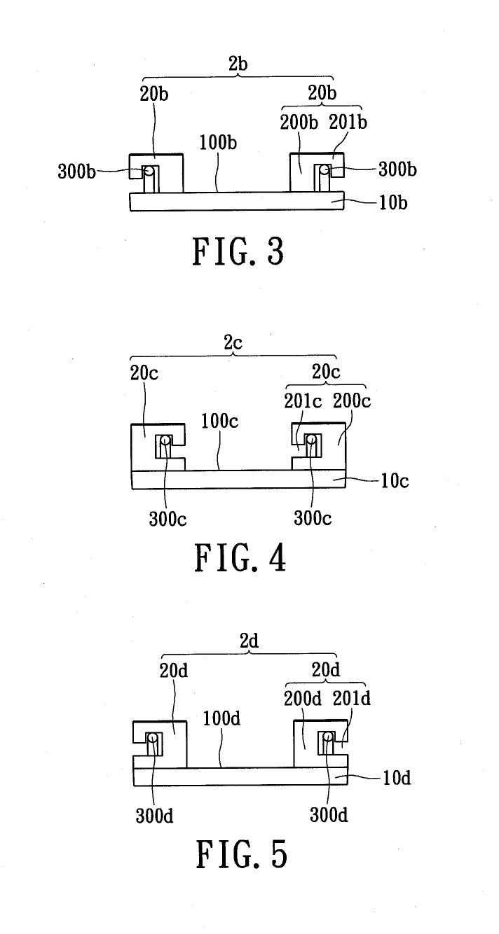

Referring to FIG. 3 (one part of the receiving body is omitted), the difference between the second embodiment and the first embodiment is that: in the second embodiment, each retaining element 20b of the retaining unit 2b has an extending portion 200b extended from a datum plane 100b of the back side of the receiving body 10b and a retaining portion 201b extended outwards from the extending portion 200b, and each pin portion 300b is positioned by each retaining portion 201b.

Referring to FIG. 4 (one part of the receiving body is omitted), the difference between the third embodiment and the first embodiment is that: in the third embodiment, each retaining element 20c of the retaining unit 2c has an extending portion 200c extended from a datum plane 100c of the back side of the receiving body 10c and an open retaining space 201c extended inwards from an inner side of the extending portion 200c, and each pin portion 300c is positioned in each open retaining space 201c.

Referring to FIG. 5 (one part of the receiving body is omitted), the difference between the fourth embodiment and the third embodiment is that: in the fourth embodiment, each retaining element 20d of the retaining unit 2d has an extending portion 200d extended from a datum plane 100d of the back side of the receiving body 10d and an open retaining space 201d extended inwards from an outer side of the extending portion 200d, and each pin portion 300d is positioned in each open retaining space 201d.

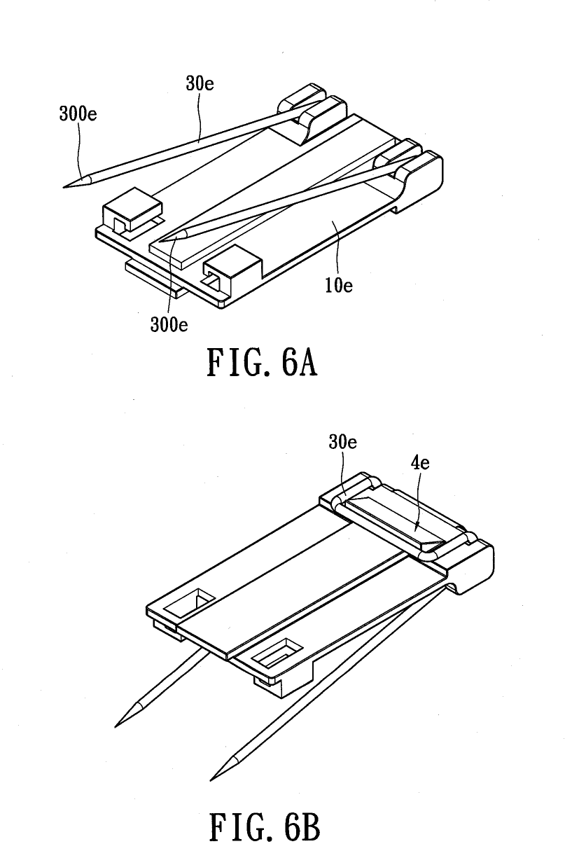

Referring to FIGS. 6A and 6B (one part of the receiving body is omitted), the difference between the fifth embodiment and the above-mentioned embodiments is that: in the fifth embodiment, the first end of each pin element 30e is positioned on a front side of the receiving body 10e and each pin element 30e has a pin portion 300e (as shown in FIG. 6A). In addition, the second end of each pin element 30e is disposed on the back side of the receiving body 10e, and the receiving body 10e has a fixing unit 4e disposed on the front side thereof for positioning the first end of each pin element 30e (as shown in FIG. 6B). For example, the fixing unit 4e may be a fixing block.

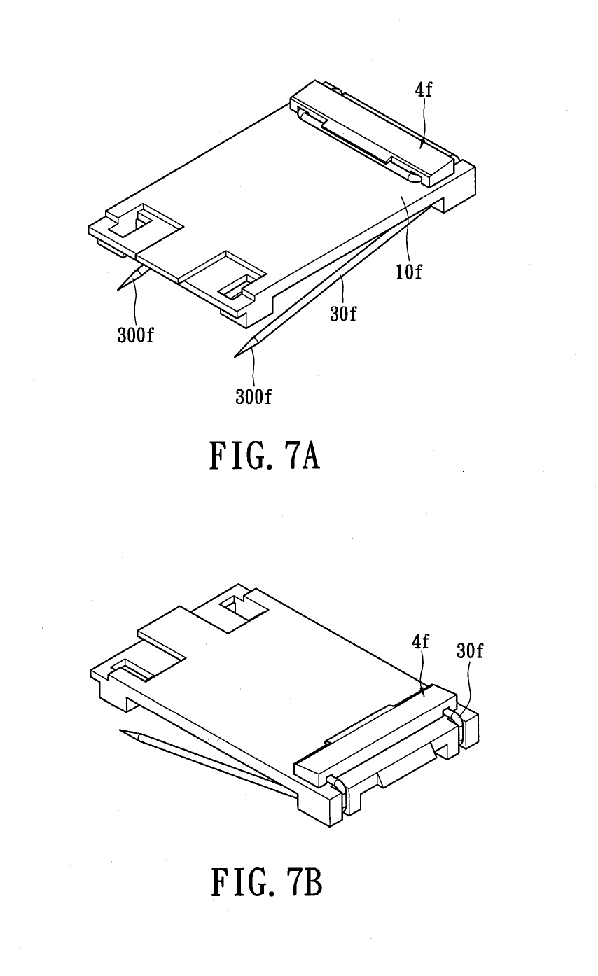

Referring to FIGS. 7A and 7B (one part of the receiving body is omitted), the first end of the pin element 30f is positioned on a front side of the receiving body 10f and the pin element 30f has two pin portions 300f (as shown in FIG. 7A). In addition, the second end of the pin element 30f is disposed on the back side of the receiving body 10f, and the receiving body 10f has a fixing unit 4f disposed on the front side thereof for positioning the first end of the pin element 30f (as shown in FIG. 7B). Therefore, the difference between the sixth embodiment and the fifth embodiment is that: in the sixth embodiment, the fixing unit 4f may be a fixing cover for covering the first end of the pin element 30f.

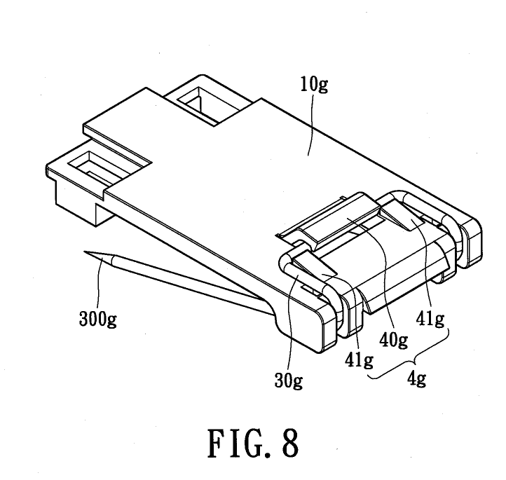

Referring to FIG. 8 (one part of the receiving body is omitted), the first end of the pin element 30g is positioned on a front side of the receiving body 10g and the pin element 30g has two pin portions 300g. In addition, the second end of the pin element 30g is disposed on the back side of the receiving body 10g, and the receiving body 10g has a fixing unit 4g disposed on the front side thereof for positioning the second end of the pin element 30g. Therefore, the difference between the seventh embodiment and the sixth embodiment is that: in the seventh embodiment, the fixing unit 4g may be a retaining set for retaining the second end of the pin element 30g, and the fixing unit 4g (the retaining set) may be composed of a hooking portion 40g and two fixing blocks 41g.

In conclusion, when the dual-purpose receiving structure uses the pin unit to insert into a wall, the instant disclosure can be applied to a wall surface. When one side of the pin unit is received in the retaining unit, the instant disclosure can be applied to a desk surface. Hence, the dual-purpose receiving structure of the instant disclosure can be selectively applied to the wall surface or the desk surface according to different requirements. In addition, the design of receiving one side of the pin unit in the retaining unit can prevent the user from being injured by the pin portion of the pin unit, thereby the safety of using instant disclosure is increased.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A dual-purpose receiving structure selectively applied to desk surface or wall surface, comprising:
a receiving unit having a receiving body and at least one open receiving space formed in the receiving body;
a retaining unit having at least one retaining element disposed on the receiving body; and
a pin unit having at least one pin element, wherein a first end of the at least one pin element is positioned on the receiving body or embedded into the receiving body, and a second end of the at least one pin element is a pin portion selectively positioned by the at least one retaining element.

2. The dual-purpose receiving structure as claimed in claim 1, wherein the at least one open receiving space is formed on a front side of the receiving body, the at least one retaining element is integrally disposed on a back side of the receiving body, and the at least one pin element is embedded into the back side of the receiving body.

3. The dual-purpose receiving structure as claimed in claim 1, wherein the at least one open receiving space is formed on a front side of the receiving body, the at least one retaining element is integrally disposed on a back side of the receiving body, the first end of the at least one pin element is positioned on the front side of the receiving body, and the second end of the at least one pin element is disposed on the back side of the receiving body.

4. The dual-purpose receiving structure as claimed in claim 3, wherein the receiving body has a fixing unit disposed on the front side thereof for positioning the first end of the at least one pin element.

5. The dual-purpose receiving structure as claimed in claim 4, wherein the fixing unit is a fixing block.

6. The dual-purpose receiving structure as claimed in claim 4, wherein the fixing unit is a fixing cover.

7. The dual-purpose receiving structure as claimed in claim 4, wherein the fixing unit is composed of a hooking portion and two fixing blocks.

8. The dual-purpose receiving structure as claimed in claim 1, wherein the at least one retaining element has an extending portion extended from a back side of the receiving body and a retaining portion extended inwards from the extending portion, and the pin portion is positioned by the retaining portion.

9. The dual-purpose receiving structure as claimed in claim 1, wherein the at least one retaining element has an extending portion extended from a back side of the receiving body and a retaining portion extended outwards from the extending portion, and the pin portion is positioned by the retaining portion.

10. The dual-purpose receiving structure as claimed in claim 1, wherein the at least one retaining element has an extending portion extended from a back side of the receiving body and an open retaining space extended inwards from an inner side of the extending portion, and the pin portion is positioned in the open retaining space.

11. The dual-purpose receiving structure as claimed in claim 1, wherein the at least one retaining element has an extending portion extended from a back side of the receiving body and an open retaining space extended inwards from an outer side of the extending portion, and the pin portion is positioned in the open retaining space.

12. A dual-purpose receiving structure selectively applied to desk surface or wall surface, comprising:
a receiving unit having a receiving body and at least one open receiving space formed in the receiving body;
a plurality of retaining units, each retaining unit having at least one retaining element disposed on the receiving body; and
a plurality of pin units, each pin unit having at least one pin element, wherein a first end of each pin element is positioned on the receiving body or embedded into the receiving body, and a second end of each pin element is a pin portion selectively positioned by each retaining element.

13. The dual-purpose receiving structure as claimed in claim 12, wherein the at least one open receiving space is formed on a front side of the receiving body, each retaining element is integrally disposed on a back side of the receiving body, and the at least one pin element is embedded into the back side of the receiving body.

14. The dual-purpose receiving structure as claimed in claim 12, wherein the at least one open receiving space is formed on a front side of the receiving body, each retaining element is integrally disposed on a back side of the receiving body, the first end of the at least one pin element is positioned on the front side of the receiving body, and the second end of the at least one pin element is disposed on the back side of the receiving body.

15. The dual-purpose receiving structure as claimed in claim 14, wherein the receiving body has a fixing unit disposed on the front side thereof for positioning the first end of the at least one pin element.

16. The dual-purpose receiving structure as claimed in claim 15, wherein the fixing unit is a fixing block.

17. The dual-purpose receiving structure as claimed in claim 15, wherein the fixing unit is a fixing cover.

18. The dual-purpose receiving structure as claimed in claim 15, wherein the fixing unit is composed of a hooking portion and two fixing blocks.

19. The dual-purpose receiving structure as claimed in claim 12, wherein each retaining element has an extending portion extended from a back side of the receiving body and a retaining portion extended inwards from the extending portion, and each pin portion is positioned by each retaining portion.

20. The dual-purpose receiving structure as claimed in claim 12, wherein each retaining element has an extending portion extended from a back side of the receiving body and a retaining portion extended outwards from the extending portion, and each pin portion is positioned by each retaining portion.

21. The dual-purpose receiving structure as claimed in claim 12, wherein each retaining element has an extending portion extended from a back side of the receiving body and an open retaining space extended inwards from an inner side of the extending portion, and each pin portion is positioned in each open retaining space.

22. The dual-purpose receiving structure as claimed in claim 12, wherein each retaining element has an extending portion extended from a back side of the receiving body and an open retaining space extended inwards from an outer side of the extending portion, and each pin portion is positioned in each open retaining space.
